(19) United States
(12) Patent Application Publication
(10) Pub. No.: US 2017/0154056 A1
(43) Pub. Date: Jun. 1, 2017

(54) MATCHING IMAGE SEARCHING METHOD, IMAGE SEARCHING METHOD AND DEVICES

(71) Applicant: BEIJING QIHOO TECHNOLOGY COMPANY LIMITED, Beijing (CN)

(72) Inventors: Xuekan QIU, Beijing (CN); Jinhui HU, Beijing (CN); Yugang HAN, Beijing (CN)

(21) Appl. No.: 15/322,074

(22) PCT Filed: Jun. 23, 2015
(86) PCT No.: PCT/CN2015/082070

§ 371 Date: Dec. 23, 2016

(30) Foreign Application Priority Data
Jun. 24, 2014 (CN) 201410286225.8
Jun. 24, 2014 (CN) 201410287038.1

(51) Int. Cl. G06F 17/30

(52) U.S. Cl. CPC G06F 17/30256; G06F 17/3028; G06F 17/30268

(57) ABSTRACT

Disclosed are matching image searching method, image searching method, image matching method and devices thereof. The matching image searching method comprises: extracting local features from a to-be-queried image; matching local features of each images in an image database with the local features of the to-be-queried image, determining a matching proportion thereof; disposing images of which the matching proportion larger than or equal to a first proportion threshold value in the image database into an image matching result; and for images having matching proportion less than the first proportion threshold value and larger than a second proportion threshold value in the database, calculating hamming distance between perceptual hashing value of the images and a perceptual hashing value of the to-be-queried image, and disposing images having hamming distances less than a set first distance threshold into the image matching result.

### CROSS-REFERENCE TO RELATED APPLICATIONS

This application is the national stage of International Application No. PCT/CN2015/082070 filed on Jun. 23, 2015, which claims the benefit of Chinese Patent Applications No. CN201410287038.1 and CN201410286225.8, both filed on Jun. 24, 2014, the entireties of which are incorporated herein by reference.

### TECHNICAL FIELD

The present invention relates to the field of Internet technology and in particular, to a matching image searching method, image searching method and the device, and an image matching method, searching method and the device thereof.

### BACKGROUND

On Internet, many images may be reproduced by different websites. During the process of the reproducing, each website may process these images (such as performing zooming, cutting, adding watermark, rotating and various PS, etc.). Recognizing these images which have similar content but being processed differently may be applied in many fields, for example, applying in relative products such as searching, dereplication, filtering, etc.

Taking a search engine as an instance, in the past, the search engine may get what the user wants when given enough key words in searching process. However, for an image searching, if a user wants to get all the images similar to a certain one, he has a “key image” only, no key word at all. For example, the user has an image in hand, he wants one of larger size, or one without watermark, or the original one before PS-processed. On the condition and premise, it is needed to search for an image with content being similar to the image (hereinafter referred to as “to-be-queried image”, in order to explain conveniently) inputted by the user, (in other words, to search for an image matching the to-be-queried image), and the searched image are able to be provided to the user as a search result.

At present, in the technology for searching matching images, the method more utilized is the one that is based on the image's local features, i.e. to extract a large amount of local features from the to-be-recognized image, which is expressed as a set of local features. While comparing the similarity of the two images, the coincidence proportion of sets of local features is made as a comparing standard; while the coincidence proportion of the set of local features of two images is larger than a certain fixed threshold value, it is considered that the two images are same. To those images of various types, because of difference of amount of local features extracted from the images, and difference of amount of repeated local features, caused by their repeated texture, etc., the difference of threshold values of coincidence proportion of the set of local features is larger. If the threshold value is chosen improper, for example, it is set too high, it may occur that a lot of actually matched images are not being searched out (i.e. the amount of accurately matched images is less relatively); and if the threshold value is set too low, a lot of inaccurately matched images are searched out, yet there is no any similarity between incorrect images and the original one, seen entirely.

### SUMMARY

In view of the problems above, the present invention discloses a matching image searching method, image searching method and its device, and an image matching method, searching and its device, in order to overcome or at least solve part of the aforementioned problems.

According to one aspect, the present invention discloses a matching image searching method, which comprises: extracting local features from a to-be-queried image inputted by a user; matching local features of each image in an image database with the local features of the to-be-queried image, determining a matching proportion between the local features of each image in the image database and the local features of the to-be-queried image; disposing the images in the database of which the matching proportion is larger than or equal to a first proportion threshold value into an image matching result; and for each image in the image database of which the matching proportion is less than the first proportion threshold value and larger than a second proportion threshold value, calculating a hamming distance between a perceptual hashing value of the image and the perceptual hashing value of the to-be-queried image, disposing the image of which the hamming distance is less than a set first distance threshold value into the image matching result; wherein the first proportion threshold value is larger than the second proportion threshold value.

According to another aspect, the present invention discloses an image searching method, which comprises: receiving a to-be-queried image inputted by a user, extracting local features from the to-be-queried image; searching images matching the to-be-queried image inputted by the user based on the local features of the to-be-queried image; and returning the searched images, as a search result, to the user.

According to still another aspect, the present invention discloses a matching image searching device, comprising: a to-be-queried image extractor, configured to extract local features of an to-be-queried image inputted by a user; a matching proportion determining module, configured to match local features of each image in an image database with the local features of the to-be-queried image, determine a matching proportion between the local features of each image in the image database and the local features of the to-be-queried image; a calculating module, configured to calculate, for each image in the image database of which the matching proportion is less than the first proportion threshold value and larger than a second proportion threshold value, a hamming distance between a perceptual hashing value of the image and the perceptual hashing value of the to-be-queried image; a matching result determining module, configured to dispose the image in the database of which the matching proportion is larger than or equal to a first proportion threshold value, and the image in the image database of which the matching proportion is less than the first proportion threshold value and larger than a second proportion threshold value, and the hamming distance is less than a set first distance threshold value into the image matching result according to the determined result of the matching proportion determining module; wherein the first proportion threshold value is larger than the second proportion threshold value.

According to still another aspect, the present invention discloses an image searching device, comprising: an input interface, configured to receive a to-be-queried image inputted by a user; an image querying apparatus, configured to initiate a request to search the image matching the to-be-queried image, and obtain the image which matches the to-be-queried image inputted by the user based on a local feature of the to-be-queried image; and an output interface, configured to return the searched image, as a search result, to the user.

According to the embodiment of the present invention, the beneficial effect includes that:

The aspects of present invention provide a matching image searching method, image searching method and device, by setting up two matching threshold values, which is the first proportion threshold value and the second proportion threshold value, in which the first proportion threshold value is larger than the second proportion threshold value, the larger matching threshold value is used to match local features (i.e. to put the images which have a matching proportion larger than or equal to the first proportion threshold value in the database into the image matching result), and on the basis of this, each image of which the matching proportion is less than the first proportion threshold value and larger than the second proportion threshold value, is sieved with matching way of perceptual hashing, calculating the hamming distance between perceptual hashing value of each image of which the matching proportion is less than the first proportion threshold value and larger than the second proportion threshold value and perceptual hashing value of the image inputted by a user; then disposing the images of which the hamming distance value is less than the set first distance threshold value, into the image matching result; in this way, on the one hand, using the larger matching threshold value guarantees the accuracy of images matched, on the other hand, the images of which the local features matching coincidence proportion is between the larger matching threshold value and the less matching threshold value, are further sieved with the way of perceptual hashing, on the premise of guaranteeing the accuracy of sieved images, the quantity of images in the image search result is increased.

According to another aspect, the present invention discloses an image matching method, comprising: extracting a plurality of local features from at least two to-be-matched images, respectively; filtering or down-grading a particular local feature in the plurality of local features, wherein the particular local feature is the local feature of which average times appearing in a single image is larger than a set threshold value; and calculating the coincidence proportion of the local features of each to-be-matched image after filtering or down-grading the particular local feature, and determining the similarity between the to-be-matched images.

According to another aspect, the present invention discloses an image matching device, comprising: an extractor, configured to extract a plurality of local features from at least two to-be-matched images, respectively; a filtering/down-grading processing module, configured to filter or down-grade a particular local feature in the plurality of local features, wherein the particular local feature is the local feature of which average times appearing in a single image is larger than a set threshold value; a calculating module, configured to calculate the coincidence proportion of the local features of each to-be-matched image after filtering or down-grading the particular local feature; and a similarity determining module, configured to determining the similarity between the to-be-matched images according to the coincidence proportion.

According to the embodiment of the present invention, the beneficial effect includes that:

the aspects of present invention provide an image matching method, image searching method and device, by extracting a plurality of local features from at least two to-be-matched images, respectively, filtering or down-grading a particular local feature included in the local features, wherein the particular local feature is the local feature whose average appearing times in a single image is larger than a set threshold value, this kind of features are the features which easily appears in an image repeatedly; calculating the coincidence proportion of local features of each to-be-matched image after filtering or down-grading the particular local feature of the to-be matched images, to determine the similarity among the to-be-matched images. On the basis of the method for matching local features, in the embodiment of the present invention, by filtering and down-grading the local features which appear easily and repeatedly in an image, a higher matching accuracy may be achieved, compared with the geometric verification method in the conventional technology, the present invention is of simple processing, less RAM consumption and higher efficiency.

According to another aspect, the present invention discloses a computer program comprising a computer-readable code which causes a computing device to perform the matching image searching method, the image matching method and/or the image searching method above when the computer-readable code is running on the computing device.

According to another aspect, the present invention discloses a computer-readable medium storing the above-mentioned computer program.

Described above is merely an overview of the inventive scheme. In order to more apparently understand the technical means of the disclosure to implement in accordance with the contents of specification, and to more readily understand above and other objectives, features and advantages of the disclosure, specific embodiments of the disclosure are provided hereinafter.

### BRIEF DESCRIPTION OF THE DRAWINGS

Through reading the detailed description of the following preferred embodiments, various other advantages and benefits will become apparent to those of ordinary skills in the art. Accompanying drawings are merely included for the purpose of illustrating the preferred embodiments and should not be considered as limiting of the present invention. Further, throughout the drawings, like reference signs are used to denote like elements. In the drawings:

FIG. 1 is a flow chart of the matching image searching method according to an embodiment of the present invention;

FIG. 2 is a flow chart of the method according to an embodiment of the present invention;

FIG. 3 is a flow chart of the image searching method according to an embodiment of the present invention;

FIG. 4 is a schematic diagram of the structure of the matching image searching device, according to an embodiment of the present invention;

FIG. 5 is a block diagram of the structure of the image searching device according to an embodiment of the present invention;

FIG. 6 is a flow chart of the image matching method according to an embodiment of the present invention;

FIG. 7 is a flow chart of the step of generating list of particular local features according to an embodiment of the present invention;

FIG. 8 is a flow chart of the image searching method according to an embodiment of the present invention;

FIG. 9 is a schematic diagram of the structure of the image matching device according to an embodiment of the present invention;

FIG. 10 is a schematic diagram of the structure of the image searching device according to an embodiment of the present invention;

FIG. 11 is a block diagram of a computing device for performing the matching image searching method, the image matching method and/or the image searching method according to the present invention; and

FIG. 12 is a schematic diagram of a memory cell for maintaining or carrying a program code for implementing the matching image searching method, the image matching method and/or the image searching method according to the present invention.

### DESCRIPTION OF THE EMBODIMENTS

Hereinafter, the present invention is further described in accompanying with figures and embodiments.

Hereinafter, a matching image searching method, image searching method and device, provided by embodiments of the present invention is further described in accompanying with figures in the specification.

The matching image searching method provided by embodiments of the present invention improves the conventional image matching method based on local features matching, infuses the image matching method based on perceptual hashing into the image matching method based on local features matching, and comprehensively utilizes local features and perceptual hashing, on the basis of satisfying the quantity of the image search result, to guarantee the accuracy of the search result.

The image matching method based on perceptual hashing, simply to say, is to extract its perceptual features out of an image in order to describe the entire image. Each image may be expressed as a binary string of 0 and 1 in a fixed length (64-bit), if the hamming distance of two binary strings (number of different bit) is lower than a certain threshold value, the two images are considered to be matched images.

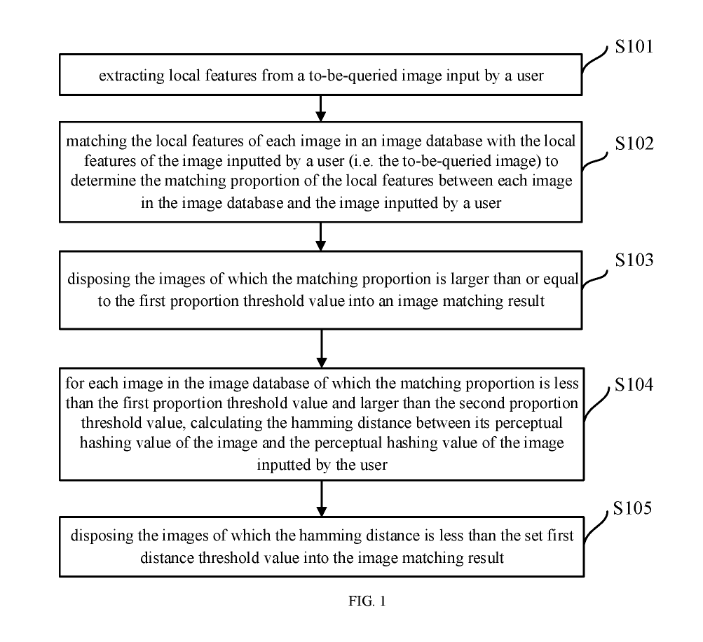

Specifically to say, referring to FIG. 1, it shows an image matching method provided by embodiments of the present invention, which includes the following steps:

S101, extracting local features from a to-be-queried image inputted by a user;

in the step, the quantity of the extracted local features may be preset;

S102, matching the local features of each image in an image database with the local features of the image inputted by a user (i.e. the to-be-queried image) to determine the matching proportion of the local features between each image in the image database and the image inputted by a user;

S103, disposing the images of which the matching proportion is larger than or equal to the first proportion threshold value into an image matching result;

S104, for each image in the image database of which the matching proportion is less than the first proportion threshold value and larger than the second proportion threshold value, calculating the hamming distance between its perceptual hashing value of the image and the perceptual hashing value of the image inputted by the user;

S105, disposing the images of which the hamming distance is less than the set first distance threshold value into the image matching result.

Hereinafter, the S101 to S105 above are described in detail respectively:

In the embodiment of the present invention, two matching threshold values are preset, which are the first proportion threshold value and the second proportion threshold value. The first proportion threshold value is larger than the second proportion threshold value.

In the method above, the following steps need to be implemented:

in an off-line state, extracting off-line features of each image in the image database in advance, which includes extracting perceptual hashing value and/or local features of set quantity;

after extracting, for the convenience of the following searching matched images, it is capable to store the extracted perceptual hashing value and a set quantity of the local features. The quantity of extracted examples may be up to hundreds.

When storing, it is capable to use such a storage way, as perceptual hashing value list and local features list stored in the database. Each list stores correspondences of the image identifications and a plurality of corresponding perceptual hashing values (a plurality of local features).

In this way, in the subsequent steps S102 and S104, it is capable to implement local features matching and hamming distance calculating, by directly utilizing the stored local features and perceptual hashing values extracted from each image, so as to improve calculating efficiency.

The step of extracting local features in S101 may be achieved by conventional technology, which is not described herein for the purpose of brevity.

In steps S101 to S105, by setting two matching threshold values, which are the first proportion threshold value and the second proportion threshold value, wherein the first proportion threshold value is larger than the second proportion threshold value, the larger matching threshold value is used to match local features (i.e. to dispose the images of which the matching proportion are equal to or larger than the first proportion threshold value in the database into the image matching result), and on the basis of this, each image of which the matching proportion is less than the first proportion threshold value and larger than the second proportion threshold value is sieved with matching way of perceptual hashing, calculating the hamming distance between perceptual hashing value of each image of which the matching proportion of is less than the first proportion threshold value and larger than the second proportion threshold value and perceptual hashing value of the image inputted in by a user; then dispose the image of which the hamming distance value is less than the set first distance threshold value into the image matching result; in this way, on the one hand, using the larger matching threshold value guarantees the accuracy of images matched, on the other hand, the images of which the local features matching coincidence proportion is between the larger matching threshold value and the less matching threshold value are further sieved with the way of perceptual hashing, on the premise of guaranteeing the accuracy of sieved images, the quantity of images in the image search result is increased.

In order to further increase the quantity of searched images on the basis of guaranteeing the accuracy of sieved images, the second distance threshold value which is another one for measuring hamming distance is set in the image matching method in embodiments of the present invention, wherein the second distance threshold value is less than the first distance threshold value, accordingly, on the basis of steps S101 to S105, the following steps are also to be implemented:

determining all the images in the database of which the matching proportions are less than the first proportion threshold value and larger than the second proportion threshold value and the hamming distances are less than the set second distance threshold value, and disposing the images into a reference set;

for each image in the reference set, using each local feature of the image to match each local feature of the image inputted by the user, and calculating the matching proportion of the local features of the image with the image inputted by the user;

determining the minimum value in the matching proportions corresponding to the images in the reference set.

The reference set is a set of images of which the matching proportion is less than the first proportion threshold value and larger than the second proportion threshold value when using local feature matching, and the hamming distance is less the second distance threshold value (the second proportion threshold value being less than the first distance threshold value) when using perceptual hashing matching. Therefore, the reference set is a sub-set of the images determined in step S105 of which the hamming distance is less than the set first distance threshold value. In other words, the images in the reference set is closer to the images inputted by the user among all the images of which the matching proportion is less than the first proportion threshold value and larger the second proportion threshold value when using local feature matching, and the hamming distance is less the set first distance threshold value. When the minimum value of matching proportion value of the local features matching of those images is used as reference value (which may be considered as an image very close to the one the user input), it is capable to further sieved the images which match the images inputted by the user, from the images of which the matching proportion of the local features is less than the first proportion threshold value and larger the second proportion threshold value, and the hamming distance is larger than or equal to the set first distance threshold value, so as to widen image matching scope for image-selecting.

Therefore, when determining the minimum value among the matching proportions corresponding to the images in the reference set, the image matching method provided by embodiments of the present invention may further comprise:

determining all the images in a database of which the matching proportion is less than the first proportion threshold value and larger than the second proportion threshold value, and the hamming distance is larger than or equal to the set second distance threshold value, and disposing the determined images into a candidate result set;

for each image in the candidate result set, using each local feature of the image to match each local feature of the image inputted by the user, calculating the matching proportion of local features between the image and the image inputted by the user; and

disposing the images in the candidate result set of which the matching proportion is larger than the minimum value into an image matching result.

Based on the steps above, the images in the candidate result set of which the matching proportion is larger than the minimum value are disposed into an image matching result. In other words, the image very close to the image inputted by the user is used as a reference, and the images in the candidate set of which the matching proportion value of the local feature is larger than the matching proportion value of the local feature of the reference image is taken as the image in the search result, so that on the premise of guaranteeing the accuracy of matched images, the quantity of images in the image search result is increased.

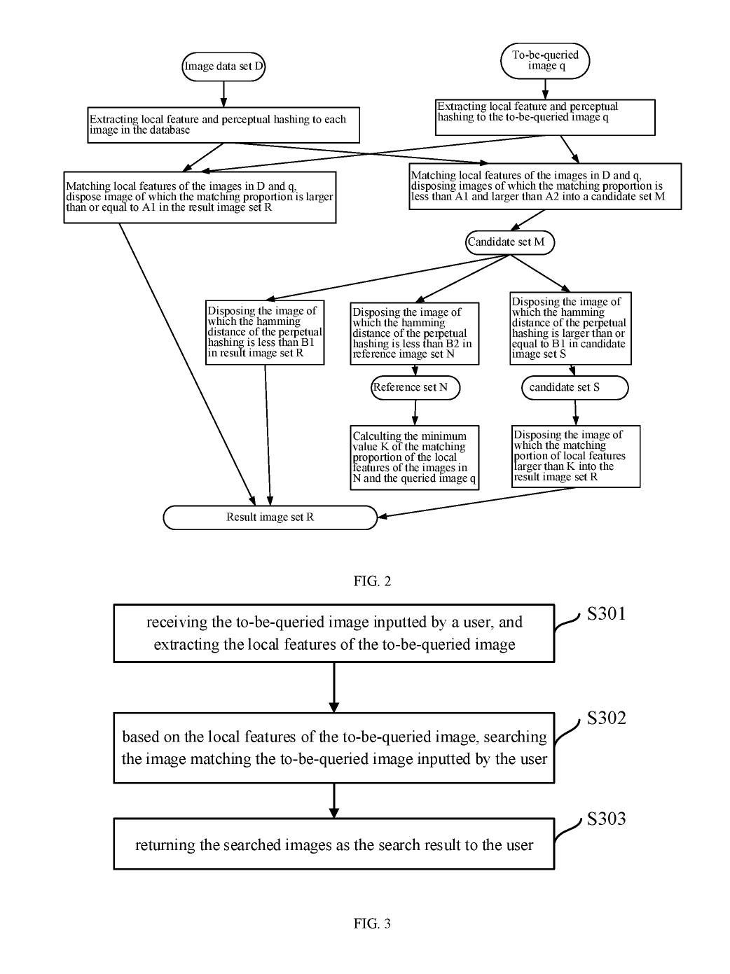

A practical example is taken to describe the method better. As shown in FIG. 2, the process of the method is to be described as follows.

Pre-setting four threshold values, namely A1, A2 (for local features, A1>A2), and B1, B2 (for perceptual hashing, B1>B2).

At first, extracting the off-line features from each image in an image database, which includes 64-bit perceptual hashing and local feature set (the set-element number is not limited, about hundreds).

Then, similarly, extracting the perceptual hashing and local features from the to-be-queried image inputted by the user.

Then, disposing the images of which the matching proportion of the local features is larger than or equal to A1 into a result image set R, and disposing the images of which the matching proportion of the local features is less than A1 but larger than A2 into a candidate image set M.

Furthermore, disposing the images in the image set M of which the hamming distance of perceptual hashing is less than B1 into the result image set R, disposing the other images in the image set M (the perceptual hashing distance being larger than or equal to B1) into the candidate image set S, and disposing all the images of which the perceptual hashing distances are less than B2 into an adjusting reference set N. (The images in the adjusting reference set N are used to guide in adjusting local features matching threshold value, due to their perceptual hashing values being very much close to that of the queried image).

The minimum value K of matching proportion of the local features of all the images in the image set N is obtained.

Then all the images in the image set S are traversed, and the image of which the matching proportion of the local features exceeds K is disposed into the result image set R.

Thus all the images in the result image set R are the search result.

Compared with the image matching method entirely using of local feature matching, in the method provided in FIG. 2, on the one hand, the perceptual hashing is used to adjust the matching threshold value of the local feature self-adaptively (i.e. decreasing the matching threshold value from A1 to K), on the other hand, the fusion of perceptual hashing with local features help to increase the quantity of search result (those images of which the local hashing matching proportion is between A2 and K and the perceptual hashing distance is less than B1 may be added into the result set).

In addition, compared with the image matching method entirely using perceptual hashing in the conventional technology, in the method in FIG. 2, it is very effective to use the local feature to solve the problems that the images are not able to be determined the same after the operation such as cut, rotated, etc., as well as the problems, like that it is not so robust for the operation (especially cutting) because of image matching depended only on perceptual hashing, and that not able to accurately match the images operated with cutting, watermark-adding, etc.

Referring to FIG. 3, it shows an image searching method, provided by embodiments of the present invention, which comprises following steps:

S301, receiving the to-be-queried image inputted by a user, and extracting the local features of the to-be-queried image;

S302, based on the local features of the to-be-queried image, searching the image matching the to-be-queried image inputted by the user; and

S303, returning the searched images as the search result to the user.

Wherein the S302, the step of searching the image the same as the image inputted by the user may use the matching image searching method provided by the present invention, the concrete implementing procedure see also the above-mentioned matching image searching method.

For example, furthermore, step S302 may include:

extracting local features of a to-be-queried image inputted by a user;

extracting local features of each image in an image database, matching the local features with the local features of the to-be-queried image, and determining a matching proportion of the local features between each image in the database and the to-be-queried image;

disposing the images in the database of which the matching proportion is larger than or equal to a first proportion threshold value into an image matching result set;

for each image in the database of which the matching proportion is less than the first proportion threshold value and larger than the second proportion threshold value, calculating the hamming distance between the image's perceptual hashing value and the perceptual hashing value of the to-be-queried image, and disposing the image of which the hamming distance is less than the set first distance threshold value into an image matching result; the first proportion threshold value is larger the second proportion threshold value; the images in the image matching result are regarded as the images matching the to-be-queried image.

Based on the same inventive concept, the embodiments of the present invention further discloses a matching image searching device and an image searching device, for the reason that the principle of the devices to solve problems and the above-mentioned matching image searching method and the image searching method are similar, implementation of the devices, may be seen in the implement of the above-mentioned methods, the repeated part is not illustrated for the purpose of brevity.

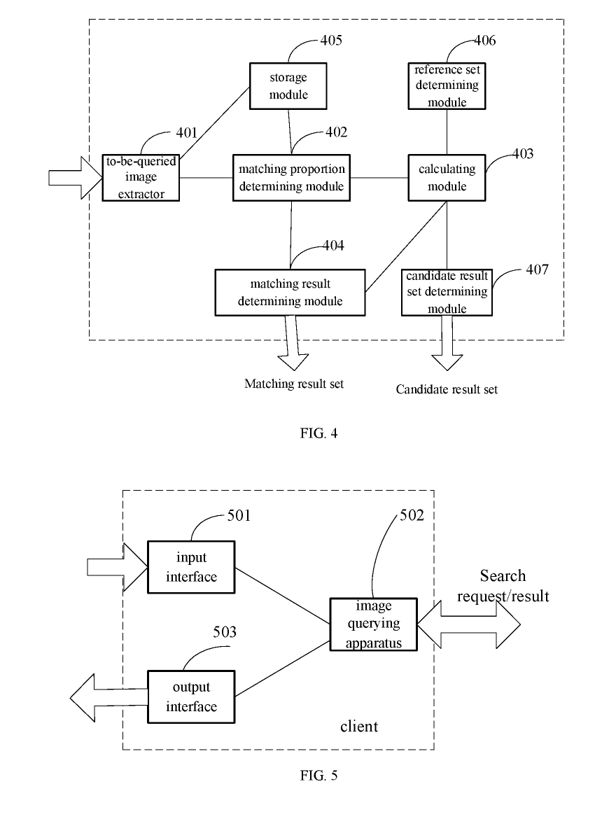

Referring to FIG. 4, it shows a matching image searching device provided by the embodiments of the present invention, which includes:

a to-be-queried image extractor 401, configured to extract local features of to-be-queried image inputted by a user;

a matching proportion determining module 402, configured to match the local features of each image in an image database with the local features of the to-be-queried image to determine the matching proportion of the local features between each image in the image database and the image inputted by a user;

a calculating module 403, configured to, for each image in the image database of which the matching proportion is less than the first proportion threshold value and larger than the second proportion threshold value, calculate the hamming distance between the perceptual hashing value of the image and the perceptual hashing value of the image inputted by the user;

a matching result determining module 404, configured to, on the basis of the determining result of the matching proportion determining module 402, disposing the images in the database of which the matching proportion is larger than or equal to a first proportion threshold value, as well as the images in the database of which the matching proportion is less than the first proportion threshold value and larger than the second proportion threshold value, and the hamming distance of which is less than the set first distance threshold value, into an image matching result; wherein the first proportion threshold value is larger than the second proportion threshold value;

Furthermore, the matching image searching device may further include a storage module 405, as shown in FIG. 4.

Accordingly, the to-be-queried image extractor 401 is further used for extracting the off-line features of each image in the image database in advance, the off-line features including the perceptual hashing value and local features of a set quantity.

The storage module 405 is configured to store the perceptual hashing value and a set quantity of local features of each image in the database, which are extracted in advance;

In a practical implementation, the storage module 405 may be in a database form.

Referring to FIG. 4, the image matching device provided by the embodiments of the present invention further includes:

a reference set determining module 406, configured to determine the images in the database of which the matching proportion is less than the first proportion threshold value and larger than the second proportion threshold value and the hamming distance is less than the set second distance threshold value, and dispose the images in a reference set; wherein the second distance threshold value is less than the first distance threshold value;

Accordingly, the calculating module 403 is further configured to, for each image in the reference set, match each local feature of the image with each local feature of the image inputted by the user, calculate the matching proportion between the local features of the image and the local features of the image inputted by the user, and determine the minimum value of the matching proportions corresponding to each image in the reference set.

Referring to FIG. 4, the image matching device provided by the embodiments of the present invention further includes:

a candidate result set determining module 407, configured to dispose all the images in the database of which the matching proportion is less than the first proportion threshold value and larger than the second proportion threshold value and the hamming distance is larger than or equal to the set second distance threshold value into a candidate result set;

correspondingly, the calculating module 403 is further configured to, for each image in the candidate result set, match each local feature of the image with each local feature of the image inputted by the user, and calculate the matching proportion of the local features of the image and the image inputted by the user; and

a matching result determining module 404, configured to dispose the images in the candidate result set of which the matching proportion is larger than the minimum value into the image matching result.

Referring to FIG. 5, the image searching device provided by the embodiments of the present invention includes:

an input interface 501, configured to receive the to-be-queried image inputted by a user;

an image querying apparatus 502, configured to initiate a request to search the image matching the to-be-queried image, and obtain the image which matches the to-be-queried image inputted by the user, based on the local features of the to-be-queried image;

an output interface 503, configured to return the searched image as the search result to the user.

Furthermore, in the image searching device above, the way of obtaining the image matching the to-be-queried image may be realized on the basis of the technical solution described by the present invention. For example:

extracting local features of a to-be-queried image inputted by a user;

extracting local features of each image in an image database, matching the local features with the local features of the to-be-queried image, and determining a matching proportion of the local features between each image in the database and the to-be-queried image;

disposing the images in the database of which the matching proportion is larger than or equal to a first proportion threshold value into an image matching result set;

for each image in the database of which the matching proportion is less than the first proportion threshold value and larger than the second proportion threshold value, calculating the hamming distance between the image's perceptual hashing value and the perceptual hashing value of the to-be-queried image, and disposing the image of which the hamming distance is less than the set first distance threshold value into an image matching result; the first proportion threshold value is larger the second proportion threshold value; the images in the image matching result are regarded as the images matching the to-be-queried image.

During its practical implementing, the image searching device provided by the embodiments of the present invention may be integrated in the products such as client terminal for searching, etc.

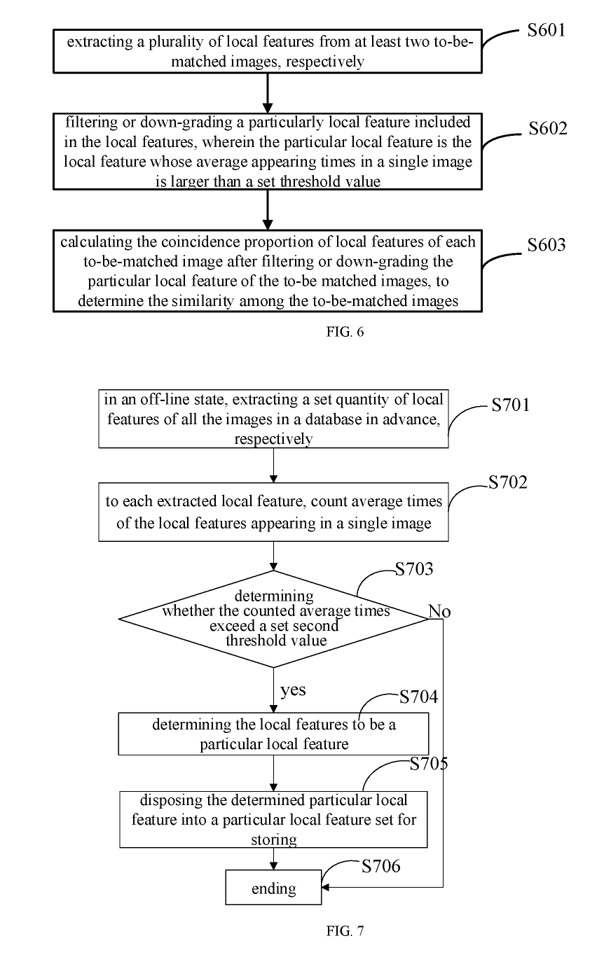

Referring to FIG. 6, embodiments of the present invention discloses an image matching method, includes the following steps:

S601, extracting a plurality of local features from at least two to-be-matched images, respectively;

S602, filtering or down-grading a particularly local feature included in the local features, wherein the particular local feature is the local feature whose average appearing times in a single image is larger than a set threshold value;

S603, calculating the coincidence proportion of local features of each to-be-matched image after filtering or down-grading the particular local feature of the to-be matched images, to determine the similarity among the to-be-matched images.

Each step above is described in detail, respectively, as below.

In the flow above, if the plurality of local features does not include particular local feature, in the image matching method provided by the embodiments of the present invention, it is capable to directly calculate the local feature coincidence proportion of the at least two to-be-matched images, thereby to determine whether the two images are the same or not. The concrete implementing process of the procedure is conventional technology, which is not described herein for the purpose of brevity.

Furthermore, in step S602, whether the plurality of local features include particular local feature may be realized in the following way:

using a plurality of local features, querying in the particular local feature set, if included in the set, determining the local features to be the particular local feature.

In the embodiments of the present invention, the particular local feature, i.e. those local features of which average times appearing in a single image is relatively large, easily re-appears in a single image. The inventor finds by his observation that, the sort of local features mostly corresponds to plaid shirt, external windows of a building, repeated dots, character area, etc., if this sort of areas is participated into the calculation of the local feature coincidence proportion, it is obvious to decrease the accuracy of image matching.

Therefore, referring to FIG. 7, in the embodiments of the present invention, the particular local feature set may be generated in the way as follows.

S701, in an off-line state, extracting a set quantity of local features of all the images in a database in advance, respectively;

the way of off-line pretreatment may increase the speed and efficiency of image matching process.

the method for extracting local features is the same as that in the conventional technology, the quantity of extracted local features may be, for example, 100 to 200.

S702, for each extracted local feature, counting average times of the local features appearing in a single image;

S703, determining whether the counted average times exceed a set second threshold value, if yes, implementing S704 below, if no, implementing S706 below.

S704, determining the local features to be a particular local feature;

S705, disposing the determined particular local feature into a particular local feature set for storing.

S706, ending the process.

After the-above procedure, in the particular local feature set, a plurality of particular local features are stored for querying.

Furthermore, in the step S702 above, the average times of the local features appearing in a single image may be counted according to the following formula:

$$Average times = \frac{the sum of times that the local feature appears}{the number of images in which the local feature appears}$$

It should be noted that the formula is not the only one to realize the present invention, but one implementing way for the embodiment. Those skilled in the art can modify the formula adaptively according to service need, and the modification is still in the range of this disclosure, e.g. adding parameters or multiple values, etc.

For example, suppose that the sum of images is 1000, wherein there is 150 images with a certain local feature, and the certain local feature appears 3000 times totally in the 150 images, then the average times of the local feature appearing in a single image is 3000/150=20.

In the above step S603, calculating the coincidence proportion of local features of each to-be-matched image using the coincidence local features after filtering or down-grading may be realized in the following way while practically implemented:

determining a weight value a of the particular local features after filtering or down-grading;

calculating the coincidence proportion of the local features of two to-be-matched images according to the following formula:

$$coincidence proportion = \frac{\begin{matrix}the sum of coincided local features after \\ filtering or down - grading\end{matrix}}{\begin{matrix}the sum of local features extracted from two \\ to - be - matched images after filtering or down - grading\end{matrix}}$$

In that, while filtering particular local feature, a is valued zero, and while down-grading a particular local feature, a is valued larger than zero and less than 1, filtering is a special circumstance of down-grading.

The sum of coincided local features after filtering or down-grading=the sum of the number of particular local feature in the coincided local features*α+the number of local features in the coincided local features excluding the particular local feature;

The sum of local features extracted from two to-be-matched images after filtering or down-grading=the number of non-coincided local features+the sum of coincided local features after filtering or down-grading.

Specifically, if the way of filtering is utilized, the sum of coincided local features after filtering equals to the sum of the coincided local features of two to-be-matched images minus the sum of the particular local feature;

The sum of filtered local features extracted from two to-be-matched images=the sum of the local features of two to-be-matched images—the sum of the particular local feature;

It should be noted that the above formula is not the only one to realize the present invention, but one implementing way for the embodiment. Those skilled in the art can modify the formula adaptively on the basis of service need, and the modification is still in the range of this disclosure, e.g. adding parameters or multiple values, etc.

For example, suppose that the quantity of local features extracted is 100 and the quantity of coincided local features is 3, wherein there is only one particular local feature, therefore, a way of filtering is utilized, calculating the coincidence proportion of local features of two to-be-matched images=(3−1)/(100−1)=2/99.

Specifically, if the way of down-grading is utilized, the sum of coincided local features after down-grading=the sum of the number of particular local feature in the coincided local features*α+the number of local features in the coincided local features excluding the particular local feature;

The sum of down-graded local features extracted from two to-be-matched images equals to the number of non-coincided local features adding the number of particular local feature in the coincided local features multiplies a, and adding the number of local features in the coincided local features excluding the particular local feature.

Suppose a equals to 0.5, the local features extracted is 100 and the number of the coincided local features is 3, wherein there is only one particular local feature, therefore, the way of down-grading is utilized, the coincidence proportion of local features of two to-be-matched images is calculated to be (0.5+2)/(0.5+2+97)=2.5/99.5.

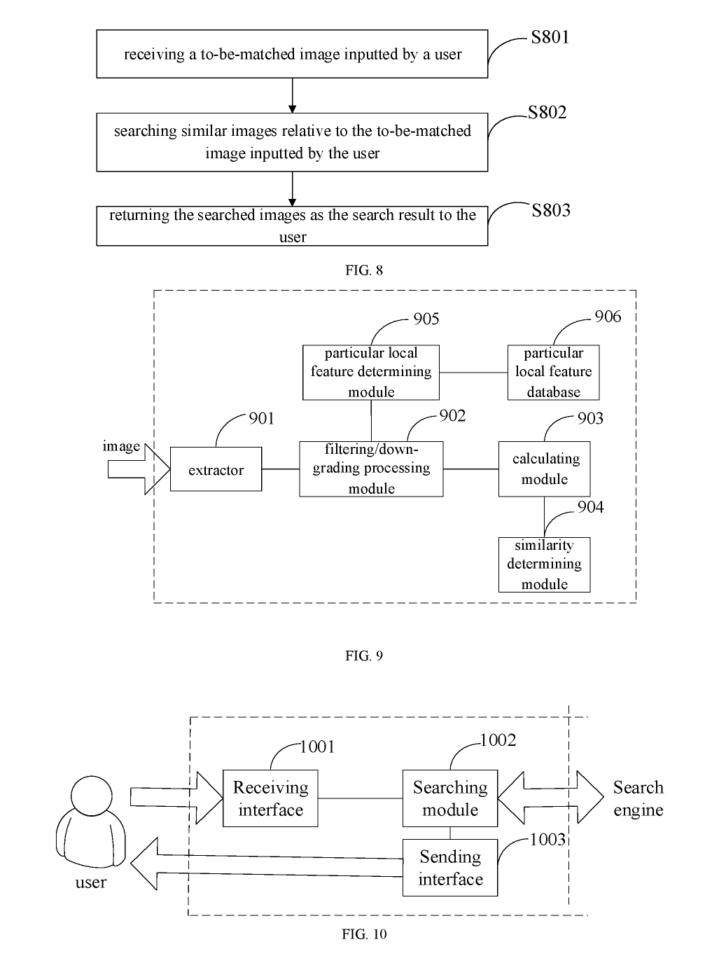

Referring to FIG. 8, the image matching method provided by the embodiments of the present invention comprises the following steps:

S801, receiving a to-be-matched image inputted by a user;

S802, searching similar images relative to the to-be-matched image inputted by the user; and

S803, returning the searched images as the search result to the user.

In the above S802, the step of searching the images similar to the image inputted by the user is realized by utilizing the above image matching method provided by the embodiments of the present invention.

Furthermore, in the image searching method, obtaining the similar images may be realized based on the method of the disclosure above. For example, extracting a plurality of local features from the to-be-matched image inputted by the user and the corresponding local features of one or more images in the search engine database; filtering or down-grading the particular local feature included in the plurality of local features, the particular local feature being those local features of which the average times appearing in a single image is larger than the set threshold value; calculating the coincidence proportion of the local features of each to-be-matched image after filtering or down-grading the particular local feature, and determining whether the to-be-matched image are similar with one or more images in the database.

Based on the same inventive concept, the embodiment of the present invention further discloses an image matching device and an image searching device, for the reason that the principle for the devices to solve problems are similar as the above-mentioned image matching method and the image searching method, implementation of the devices may see the implementation of the methods above, the repeat part is not illustrated for the purpose of brevity.

The image matching device provided by the embodiments of the present invention is shown in FIG. 9, which includes:

an extractor 901, configured to extract a plurality of local features of at least two to-be-matched images, respectively;

a filtering/down-grading processing module 902, configured to filter or down-grade the particular local features included in the plurality of local features, the particular local feature is the local feature of which the average times appearing in a single image is larger than the set threshold value;

a calculating module 903, configured to calculate the coincidence proportion of the local features of each to-be-matched image after filtering or down-grading to the particular local features;

a similarity determining module 904, configured to determine the similarity among the to-be-matched images according to the coincidence proportion.

Furthermore, the similarity determining module 904 in the above image matching device is used specifically to determine that the each to-be-matched image is similar, when the coincidence proportion of the local features of each to-be-matched image is larger than the set first threshold value after the particular local feature of each to-be-matched image is filtered or down-graded.

Furthermore, shown as FIG. 9, the above image matching device comprises: a particular local feature determining module 905, configured to count the local features of all the images in the database in advance, and obtain the statistic value which represents the average times of the local features appearing in a single image; when the statistic average times exceeds a set threshold value, the local features is determined to be a particular local feature.

Furthermore, shown as FIG. 9, the above image matching device further includes: a particular local feature database 906, wherein:

the particular local feature determining module 905 is further configured to generate a corresponding particular local feature set from the determined particular local feature;

the particular local feature database 906 is configured to store the particular local feature set;

The filtering/down-grading processing module 902 is further configured to determine the particular local feature included in a plurality of local features by querying in the particular local feature set.

Furthermore, the particular local feature determining module 905 is specifically configured to count the average times of the local feature appearing in a single image according to the following formula:

$$Average times = \frac{the sum of times that the local feature appears}{the number of images in which the local feature appears}$$

It should be noted that the formula is not the only one to realize the present invention, but one implementing way for the embodiment. Those skilled in the art can modify the formula adaptively according to service need, and the modification is still in the range of this disclosure, e.g. adding parameters or multiple values, etc.

Furthermore, the above counting module 903 is specifically configured to determine the weight value α of a particular local feature after filtering or down-grading, and calculate the coincidence proportion of the local features of the two to-be-matched images according to the following formula:

$$coincidence proportion = \frac{\begin{matrix}the sum of coincided local features after \\ filtering or down - grading\end{matrix}}{\begin{matrix}the sum of local features extracted from two \\ to - be - matched images after filtering or down - grading\end{matrix}}$$

In that, when filtering the particular local feature, a is valued zero, and when down-grading a particular local feature, a is valued larger than zero and less than 1;

the sum of coincided local features after filtering or down-grading=the sum of the number of particular local feature in the coincided local features*α+the number of local features in the coincided local features excluding the particular local feature;

the sum of local features extracted from two to-be-matched images after filtering or down-grading=the number of non-coincided local features+the sum of coincided local features after filtering or down-grading.

It should be noted that the formula is not the only one to realize the present invention, but one implementing way for the embodiment. Those skilled in the art can modify the formula adaptively according to service need, and the modification is still in the range of this disclosure, e.g. adding parameters or multiple values, etc.

Referring to FIG. 10, the embodiments of the present invention further discloses an image searching device, including:

a receiving interface 1001, configured to receive a to-be-matched image inputted by a user;

a searching module 1002, configured to search similar images relative to the to-be-matched image inputted by the user, as well as the images similar to the image inputted by the user; and

a sending interface 1003, configured to return the searched images as the search result to the user.

Furthermore, in the image searching method, obtaining the similar images may be realized based on the method of the disclosure above. For example, the search engine extracts a plurality of local features from the to-be-matched image inputted by the user and the corresponding local features of one or more images in the search engine database, respectively; filtering or down-grading the particular local feature included in the plurality of local features, the particular local feature being those local features of which the average times appearing in a single image is larger than the set threshold value; calculating the coincidence proportion of the local features of each to-be-matched image after filtering or down-grading the particular local feature, and determining whether the to-be-matched image are similar with one or more images in the database.

In the practical implementation, the-above image matching device provided by the embodiments of the present invention can be integrated in the search engine, and the image searching device provided by the embodiments of the present invention can be integrated in the searching client.

In the image matching method, the image searching method and the devices thereof provided by the embodiments of the present invention, in the coincided local feature of two to-be-matched images, whether there exists the local features of which the average times appearing in a single image is larger than the set threshold value is determined, the sort of the features are the features easily appearing repeatedly in the image, if the sort of the features which is easy to appear repeatedly exists, the features are filtered or down-graded, and then the coincidence proportion of the local features between the two to-be-matched images is calculated using the filtered or down-graded coincident local feature, and whether the two images are similar images is determined according to the calculated coincidence proportion. In the embodiments of the present invention, on the basis of the method for local features matching, it is capable to filter or down-grade the local features which easily appear repeatedly in images, a higher matching accuracy is reached, compared with the geometric verification method in the conventional technology, the methods and devices in the embodiments of the present invention are of simple processing, less RAM consumption and higher efficiency.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More precisely, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the device in the embodiments can be adaptively modified and arranged in one or more devices different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the matching image searching device, image matching device and the image matching device and searching device according to the embodiments of the present invention. The present invention may further be implemented as device program (for example, computer program and computer program product) for executing some or all of the methods as described herein. Such program for implementing the present invention may be stored in the computer readable medium, or have a form of one or more signals. Such a signal may be downloaded from the internet websites, or be provided in carrier, or be provided in other manners.

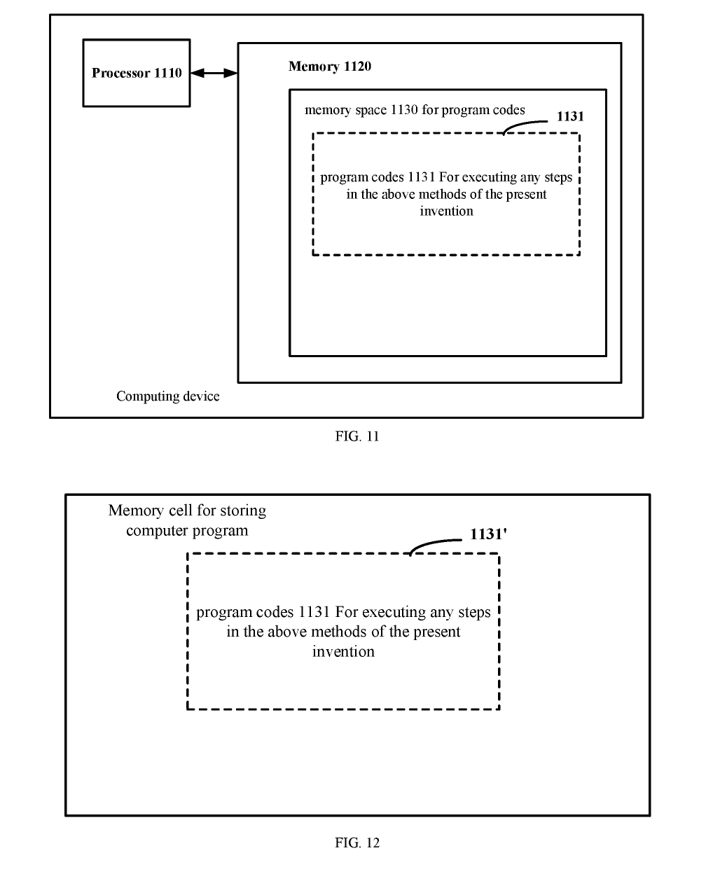

For example, FIG. 11 is a block diagram of a computing device for executing the method for image searching and/or matching image searching according to the present invention. Traditionally, the computing device includes a processor 1110 and a computer program product or a computer readable medium in form of a memory 1120. The memory 1120 could be electronic memories such as flash memory, EEPROM (Electrically Erasable Programmable Read-Only Memory), EPROM, hard disk or ROM. The memory 1120 has a memory space 1130 for program codes 1131 executing any steps in the above methods. For example, the memory space 1130 for program codes may include respective program codes 1131 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in FIG. 12. The memory cells may be provided with memory sections, memory spaces, etc., arranged similar to the memory 1120 of the electronic device as shown in FIG. 11. The program codes may be compressed, for example, in an appropriate form. Usually, the memory cell includes computer readable codes 431′ which can be read, for example, by processors 410. When these codes are operated on the computing device, the computing device may execute respective steps of the methods as described above.

The “an embodiment”, “embodiments” or “one or more embodiments” mentioned in the disclosure means that the specific features, structures or performances described in combination with the embodiment(s) would be included in at least one embodiment of the present invention. Moreover, it should be noted that, the wording “in an embodiment” herein may not necessarily refer to the same embodiment.

It should be noted that the above-described embodiments are intended to illustrate but not to limit the present invention, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the present invention. Therefore, it is obvious for an ordinary skilled person in the art that modifications and variations could be made without departing from the scope and spirit of the claims as appended. For the scope of the present invention, the publication of the inventive disclosure is illustrative rather than restrictive, and the scope of the present invention is defined by the appended claims.

1. A matching image searching method, comprising:
extracting local features from a to-be-queried image inputted by a user;
matching local features of each image in an image database with the local features of the to-be-queried image, determining a matching proportion between the local features of each image in the image database and the local features of the to-be-queried image;
disposing the images of which the matching proportion is larger than or equal to a first proportion threshold value in the database into an image matching result; and
calculating, for each image of which the matching proportion is less than the first proportion threshold value and larger than a second proportion threshold value in the image database, a hamming distance between a perceptual hashing value of the image and the perceptual hashing value of the to-be-queried image, disposing the image of which the hamming distance is less than a set first distance threshold value into the image matching result; wherein the first proportion threshold value is larger than the second proportion threshold value.

2. The method according to claim 1, wherein, the method further comprises:
extracting off-line features from each image in the image database in advance, the off-line features including the perceptual hashing value and/or the local features of set quantity.

3. The method according to claim 1 or 2, wherein, the method further comprises:
determining all the images of which the matching proportion is less than the first proportion threshold value and larger than the second proportion threshold value and the hamming distance is less than a set second distance threshold value in the database, and disposing the determined images into a reference set; wherein the second distance threshold value is less than the first distance threshold value;
matching, for each image in the reference set, each local feature of the image with each local feature of the to-be-queried image, calculating the matching proportion of the local feature of the image and the local feature of the to-be-queried image; and
determining a minimum value in the matching proportion corresponding to each image in the reference set.

4. The method according to claim 1, wherein, the method further comprises:
disposing all the images of which the matching proportion is less than the first proportion threshold value and larger the second proportion threshold value and the hamming distance is larger than or equal to a set second distance threshold value in the database into a candidate result set;
matching, for each image in the candidate result set, each local feature of the image with each local feature of the to-be-queried image, calculating the matching proportion of the local feature of the image and the local feature of the to-be-queried image; and
disposing the images of which the matching proportion is larger than the minimum value in the candidate result set into an image matching result.

5.-9. (canceled)

10. A computing device, comprising:
a memory having instructions stored thereon;
a processor configured to execute the instructions to perform operations for matching image searching, the operations comprising:
extracting local features of a to-be-queried image inputted by a user;
matching local features of each image in an image database with the local features of the to-be-queried image, determining a matching proportion between the local features of each image in the image database and the local features of the to-be-queried image;
calculating, to each image in the image database of which the matching proportion is less than the first proportion threshold value and larger than a second proportion threshold value a hamming distance between a perceptual hashing value of the image and the perceptual hashing value of the to-be-queried image;
disposing the image of which the matching proportion is larger than or equal to a first proportion threshold value in the database, and the image of which the matching proportion is less than the first proportion threshold value and larger than a second proportion threshold value, and the hamming distance is less than a set first distance threshold value in the database into the image matching result according to the determined result; wherein the first proportion threshold value is larger than the second proportion threshold value.

11. The computing device according to claim 10, wherein,
extracting local features of a to-be-queried image inputted by a user further comprises: extracting off-line features from each image in the image database in advance, the off-line features including the perceptual hashing value and/or the local features of set quantity; and
the operations further comprise: storing the perceptual hashing value and the local features of set quality of each image in the database which are extracted in advance.

12. The computing device according to claim 10, wherein, the operations further comprise:
determining all the images in the database of which the matching proportion is less than the first proportion threshold value and larger than the second proportion threshold value and the hamming distance is less than a set second distance threshold value, and disposing the determined images into a reference set; wherein the second distance threshold value is less than the first distance threshold value
calculating, for each image of which the matching proportion is less than the first proportion threshold value and larger than a second proportion threshold value in the image database, a hamming distance between a perceptual hashing value of the image and the perceptual hashing value of the to-be-queried image further comprises: matching, for each image in the reference set, each local feature of the image with each local feature of the to-be-queried image, calculating the matching proportion of the local feature of the image and the local feature of the to-be-queried image; and determining a minimum value in the matching proportion corresponding to each image in the reference set.

13. The computing device according to claim 10, wherein, the operations further comprise:
disposing all the images of which the matching proportion is less than the first proportion threshold value and larger the second proportion threshold value and the hamming distance is larger than or equal to a set second distance threshold value in the database into a candidate result set;
calculating, to each image in the image database of which the matching, proportion is less than the first proportion threshold value and larger than a second proportion threshold value, a hamming distance between a perceptual hashing value of the image and the perceptual hashing value of the to-be-queried image further comprises: matching, for each image in the candidate result set, each local feature of the image with each local feature of the to-be-queried image, calculating the matching proportion of the local feature of the image and the local feature of the to-be-queried image;
the operations further comprise:
disposing the images of which the matching proportion is larger than the minimum value in the candidate result set into an image matching result.

14.-19. (canceled)

20. A non-transitory computer-readable medium having computer programs stored thereon that, when executed by one or more processors of a computing device, cause the computing device to perform operations for matching image searching, the operations comprising:
extracting local features from a to-be-queried image inputted by a user;
matching local features of each image in an image database with the local features of the to-be-queried image, determining a matching proportion between the local features of each image in the image database and the local features of the to-be-queried image;
disposing the images of which the matching proportion is larger than or equal to a first proportion threshold value in the database into an image matching result; and
calculating, for each image of which the matching proportion is less than the first proportion threshold value and larger than a second proportion threshold value in the image database, a hamming distance between a perceptual hashing value of the image and hashing value of the to-be-queried image, disposing the image of which the hamming distance is less than a set first distance threshold value into the image matching result; wherein the first proportion threshold value is larger than the second proportion threshold value.

21. The non-transitory computer-readable medium according to claim 20, wherein, the operations further comprise:
extracting off-line features from each image in the image database in advance, the off-line features including the perceptual hashing value and/or the local features of set quantity.

22. The non-transitory computer-readable medium according to claim 20, wherein, the operations further comprise:
determining all the images of which the matching proportion is less than the first proportion threshold value and larger than the second proportion threshold value and the hamming distance is less than a set second distance threshold value in the database, and disposing the determined images into a reference set; wherein the second distance threshold value is less than the first distance threshold value;
matching, for each image in the reference set, each local feature of the image with each local feature of the to-be-queried image, calculating the matching proportion of the local feature of the image and the local feature of the to-be-queried image; and
determining a minimum value in the matching proportion corresponding to each image in the reference set.

23. The non-transitory computer-readable medium according to claim 20, wherein, the operations further comprise:
disposing all the images of which the matching proportion is less than the first proportion threshold value and larger the second proportion threshold value and the hamming distance is larger than or equal to a set second distance threshold value in the database into a candidate result set;
matching, for each image in the candidate result set, each local feature of the image with each local feature of the to-be-queried image, calculating the matching proportion of the local feature of the image and the local feature of the to-be-queried image; and
disposing the images of which the matching proportion is larger than the minimum value in the candidate result set into an image matching result.
